(19) United States
(12) Patent Application Publication
(10) Pub. No.: US 2026/0087340 A1
(43) Pub. Date: Mar. 26, 2026

(54) METHODS AND APPARATUS FOR FUSION OF SENSORY TRANSDUCTION AND NEUROMORPHIC COMPUTATION

(71) Applicant: Intel Corporation, Santa Clara, CA (US)

(72) Inventor: Ashwani Kumar, Bengaluru (IN)

(73) Assignee: Intel Corporation, Santa Clara, CA (US)

(21) Appl. No.: 19/398,986

(22) Filed: Nov. 24, 2025

(51) Int. Cl. G06N 3/065; G06N 3/049

(52) U.S. Cl. CPC G06N 3/065; G06N 3/049

(57) ABSTRACT

Methods and apparatus disclosed herein introduce a novel integration of sensing and neuromorphic computation that addresses the energy, latency, and complexity challenges of conventional event-based vision pipelines. A monolithic neuromorphic sensor fuses sensing and computation into a single neuro-transducer cell, including pixels that contain a photonic transducer, a membrane capacitor, and a Leaky Integrate-and-Fire (LIF) neuron whose membrane potential is driven directly by a raw physical stimulus rather than by an injected current. Adjacent neuro-transducers are linked by non-volatile, programmable RRAM synapses that store multi-bit weights and are updated locally via Spike-Timing-Dependent Plasticity (STDP)-compatible write pulses.

### BACKGROUND

Neuromorphic computing focuses on designing hardware and software that simulates neural and synaptic structures and functions associated with the human brain for processing information. Neuromorphic computing systems model these neurological and biological mechanisms using spiking neural networks (SNNs), a type of artificial neural network including spiking neurons and synapses for storing and processing data.

### BRIEF DESCRIPTION OF THE DRAWINGS

FIG. 1 is a block diagram of an example implementation of neuromorphic computing performer circuitry constructed in accordance with teachings of this disclosure to fuse sensing and spiking computation as part of neuromorphic computing.

FIG. 2 is a flowchart representative of example machine-readable instructions and/or example operations that may be executed, instantiated, and/or performed by example programmable circuitry to implement the example neuromorphic computing performer circuitry of FIG. 1.

FIG. 3 is a flowchart representative of example machine-readable instructions and/or example operations that may be executed, instantiated, and/or performed by the example neuromorphic computing performer circuitry of FIG. 1 to process a physical stimulus.

FIG. 4 is an example graph of Leaky Integrate-and-Fire (LIF) neural model dynamics under uniform and edge stimuli as determined using the neuromorphic computing performer circuitry of FIG. 1.

FIG. 5 is a block diagram of an example implementation of programmable circuitry structured to execute, instantiate, and/or perform the example machine readable instructions and/or perform the example operations of FIGS. 2-3 to implement the example neuromorphic computing performer circuitry of FIG. 1.

FIG. 6 is a block diagram of another example implementation of the programmable circuitry structured to execute, instantiate, and/or perform the example machine readable instructions and/or perform the example operations of FIGS. 2-3 to implement the example neuromorphic computing performer circuitry of FIG. 1.

In general, the same reference numbers will be used throughout the drawing(s) and accompanying written description to refer to the same or like parts. The figures are not necessarily to scale.

### DETAILED DESCRIPTION

Modern neuromorphic hardware (e.g., Intel® Loihi neuromorphic chip) implements Spiking Neural Networks (SNNs) to emulate the brain's event-driven, asynchronous processing. While traditional Artificial Neural Networks (ANNs) process dense numeric matrices every cycle and represent only mean spike firing rates, SNNs fire only when discrete spikes occur, using binary activation pulses of current that encode both temporal information and intensity. As such, SNNs provide significantly more information density at a higher efficiency as compared to ANNs. A leaky integrate-and-fire (LIF) neuron represents an SNN artificial neural model modeling a biological LIF neuron as a low-pass filter resistor-capacitor (RC) circuit that aggregates the membrane potential as the potential is driven by input current spikes. The LIF generates an output spike of current once the membrane potential reaches a threshold value.

Most neuromorphic devices are based on silicon and Complementary Metal-Oxide Semiconductor (CMOS) technology and can involve the use of machine learning and non-machine learning techniques as part of training and learning algorithms. Neuromorphic chips can include a built-in learning engine that supports autonomous operation and continuous adaptation through self-learning capabilities. In particular, neuromorphic computing provides computational improvements through adaptability (e.g., real-time learning and adaptation to evolving stimuli in the form of inputs and parameters), energy efficiency (e.g., event-based responses with network power consumption limited to spike computations), reduced latency (e.g., storage and processing of data in individual neurons as compared to central processing units and memory units), and parallel processing (e.g., execution of different operations concurrently based on the number of neurons). Neuromorphic chips can include more than 100,00 neurons, each neuron communicating with thousands of other neurons, with significantly accelerated learning in unstructured environments for systems that require autonomous operations and/or continuous learning while maintaining very low power consumption with high performance. However, neuromorphic computing potential is currently limited by high-overhead processes associated with second-generation neuromorphic processors, including (1) inefficient sensing, (2) a data transfer bottleneck, and (3) computationally expensive encoding, resulting in an energy and latency chasm between physical reality and neuromorphic computation.

Inefficient sensing occurs when conventional sensors (e.g., a CMOS camera) capture everything non-stop, converting a physical phenomenon into a dense, redundant digital matrix. For a standard 1-megapixel camera running at 30 frames per second (fps), this generates data at a rate of 720 megabits per second (Mbps), even if the scene is static. A data transfer bottleneck occurs when this massive stream of data must be physically moved from the sensor chip to the processor chip, consuming significant power and introducing latency. Computationally expensive encoding occurs because the neuromorphic processor cannot directly understand a pixel matrix. The 720 Mbps of dense data must be converted by a separate encoding algorithm into sparse, spatiotemporal spike trains. This encoding step can consume more energy and time than the final computation itself. As such, the entire process is fundamentally inefficient and creates a lag between an event happening in the real world and the event being perceived by artificial intelligence.

Neuromorphic systems experience a sensor-to-processor bottleneck due to dense sensing (e.g., frame-based sensors output hundreds of megabits per second occurring even when there are no changes), data transfer overhead (e.g., moving bulk data to a neuromorphic chip consumes more than 50% of the total power and adds tens of milliseconds of latency), and encoding costs (e.g., converting frames into spike trains often uses more energy and/or time than the actual SNN inference phase). As a result, real-world events require more than 30 milliseconds to be sensed and recognized, blocking always-on, ultra-low-power AI applications.

While known solutions (e.g., a Dynamic Vision Sensor (DVS) included in event-based cameras) can eliminate temporal redundancy, such an approach has key limitations, including (1) limited computation, (2) distinct circuits, and (3) identification of a representation of the change. Limited computation occurs because only brightness changes are reported without any higher-level feature extractions (e.g., edge detection, corner detection, or motion flow detection), with only outputs of a stream of simple, pixel-level events. Likewise, light-sensing elements (e.g., photodiode) and event-generation logic are still distinct circuits within the pixel, though integrated on the same chip. Additionally, while the output of a DVS is a stream of where and when a change occurred, significant downstream processing is required on a separate chip to figure out what the change represents.

Neuromorphic computing has potential applications in a variety of use cases requiring swift computations, including autonomous vehicles (e.g., improving navigational skills associated with course corrections), cybersecurity (e.g., addressing threats associated with the detection of unusual patterns or activities), edge-based artificial intelligence (e.g., providing low power consumption), robotics (e.g., assembly-line operations), and medical data analysis applications (e.g., identification of patterns for medical image processing). However, the existing limitations of neuromorphic computing (e.g., inefficient sensing, data transfer bottlenecks, computationally expensive encoding, etc.) limit the practical uses of this emerging technology.

Methods and apparatus disclosed herein introduce a monolithic device with fusion of sensory transduction and neuromorphic computation into a single unit (e.g., a neuro-transducer). In examples disclosed herein, physical phenomena can be directly converted into computationally rich spike patterns, making the sensor the initial analysis-based layer of the network. The system disclosed herein perceives the environment with extreme efficiency as opposed to merely collecting data from the environment. For example, known neuromorphic computing system arrangements include the use of a pipeline that transforms continuous physical signals into a series of discrete spikes that an SNN can interpret (e.g., sensor data being sent to an Analog-to-Digital Converter (ADC), followed by encoding to convert digital data to spikes received as inputs by an SNN). In contrast, methods and apparatus disclosed herein fuse sensing and spiking computation in the same physical device. For example, each neuro-transducer cell behaves like a leaky integrate-and-fire (LIF) neuron whose input is the raw stimulus (e.g., physical stimulus Φ(1)), instead of an injected current (e.g., current I(t)). The resulting advantages of using methods and apparatus disclosed herein include ultra-low power (<1 milliwatt per square centimeter (mW/cm²)) (e.g., applicable for a year-long battery life for wearables, structural health monitors, etc.), instantaneous perception (<100 microseconds (μs)) (e.g., applicable for closed-loop control in micro-drones, robotics, prosthetics, etc.), and presence of edge-native features (e.g., applicable for simplified Machine Learning (ML) stacks, reduced transmission bandwidth, privacy by design, etc.).

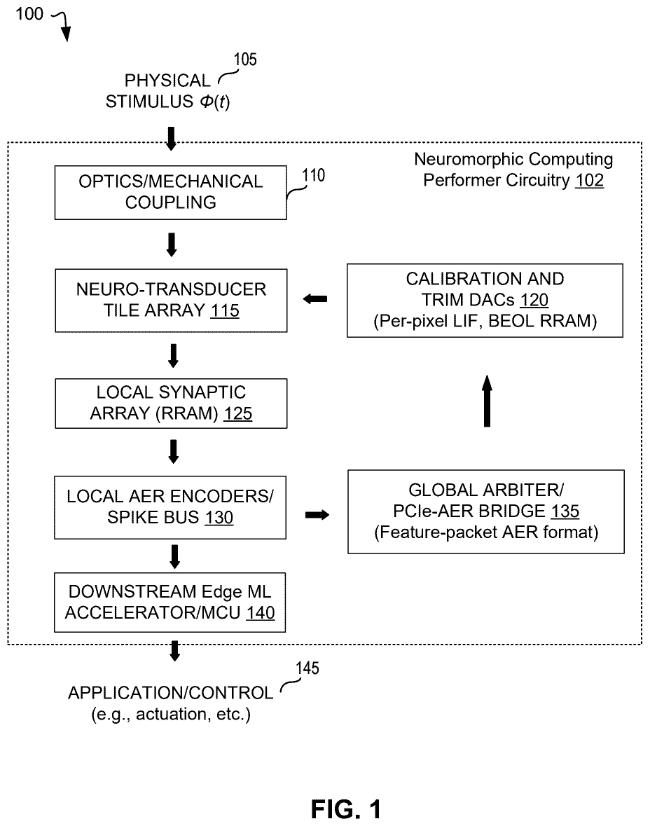

FIG. 1 is a block diagram 100 of an example implementation of neuromorphic computing performer circuitry 102 constructed in accordance with teachings of this disclosure to fuse sensing and spiking computation as part of neuromorphic computing. The neuromorphic computing performer circuitry 102 of FIG. 1 may be instantiated (e.g., creating an instance of, bring into being for any length of time, materialize, implement, etc.) by programmable circuitry. For example, programmable circuitry may be implemented by a Central Processing Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the neuromorphic computing performer circuitry 102 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

In the example of FIG. 1, the neuromorphic computing performer circuitry 102 includes example optics/mechanical coupling 110, an example neuro-transducer tile array 115, example calibration and trim digital-to-analog converters (DACs) 120, an example local synaptic array (Resistive Random-Access Memory (RRAM)) 125, example local Address-Event Representation (AER) encoders/spike bus 130, an example global arbiter/Peripheral Component Interconnect Express (PCIe)-AER bridge 135, and an example downstream edge machine learning (ML) accelerator/microcontroller unit (MCU) 140.

In the example of FIG. 1, a physical stimulus (Φ(t)) 105 (e.g., light intensity, acoustic pressure wave, mechanical strain, etc.) is received by the neuro-transducer tile array 115 via photonic/physical coupling (e.g., optics/mechanical coupling 110). In examples disclosed herein, the physical stimulus 105 can be represented by a time-varying function that drives charge and/or current into the transducer. For example, the physical stimulus 105 can represent a flash of light (e.g., vision-based stimulus), a vibration (e.g., tactile-based stimulus), or a pressure wave (e.g., audio-based stimulus). As a result, the optics/mechanical coupling 110 used to sense the physical stimulus 105 transfers the physical stimulus 105 to the neuro-transducer tile array 115. In examples disclosed herein, each neuro-transducer cell of the neuro-transducer tile array 115 behaves like a leaky integrate-and-fire (LIF) neuron whose input is the raw stimulus (e.g., physical stimulus 115), instead of an injected current (e.g., I(t)), as described in more detail below.

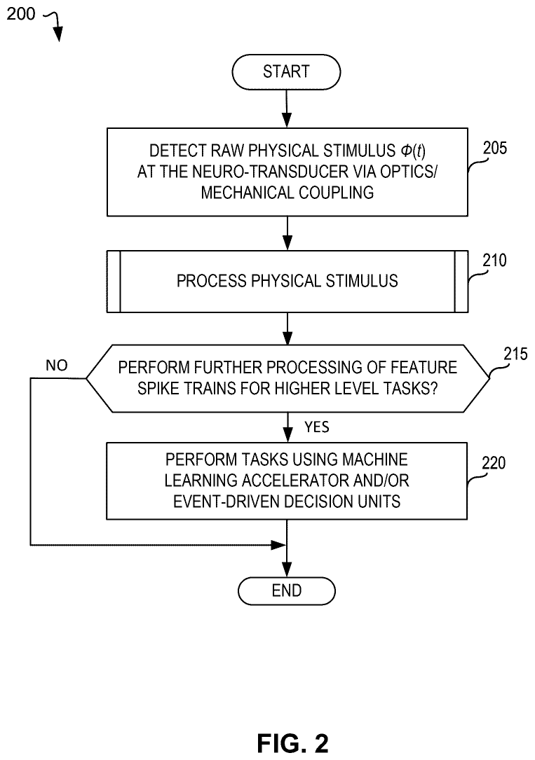

For example, the neuromorphic computing performer circuitry 102 of FIG. 1 includes a monolithic neuromorphic sensor that fuses sensing and computation into a single neuro-transducer cell. Each transducer pixel can include a photonic transducer (e.g., quantum-dot layer), a membrane capacitor, and the LIF neuron whose membrane potential is driven directly by the raw physical stimulus 105. Adjacent neuro-transducers are linked by non-volatile, programmable RRAM synapses (e.g., RRAM cells embedded in a monolithic back-end-of-line (BEOL) layer as part of the local synaptic array 125) that store multi-bit weights and are updated locally via Spike-Timing-Dependent Plasticity (STDP)-compatible write pulses. In some examples, the array is organized as a 4×4 tile with an AER-style spike bus that routes spikes to neighbors and to a global arbiter (e.g., global arbiter 135). In the example of FIG. 1, output from the neuro-transducer tile array 115 is transmitted to the local synaptic array (RRAM-based) 125 and local AER encoders/spike bus 130, which is in communication with the global arbiter/PCIe-AER bridge 135 (e.g., having a feature-packet AER format). In the example of FIG. 1, the global arbiter/PCIe-AER bridge 135 is in communication with the calibration and trim DACs 120 (e.g., associated with the per-pixel LIF and BEOL RRAM). As described in more detail in connection with FIG. 2, output from the local AER encoders/spike bus 130 is received by a downstream edge machine learning (ML) accelerator/microcontroller unit (MCU) 140 for further processing to allow for the use of the physical stimulus 105 as part of a desired application and/or control action 145 (e.g., actuation).

A typical LIF neural model is shown in connection with Equation 1, where τₘ represents a membrane time constant, Vᵣₑₛₜ represents a resting membrane potential, Vₘ represents the membrane potential, Rₘ represents a membrane resistance, and I(t) represents the input current:

$${τ}_{m} \frac{{dV}_{m}}{dt} = - ( {V}_{m} - {V}_{rest} ) + {R}_{m} I ( t ) \qquad Equation 1$$

In the example of Equation 1, when I'm exceeds a threshold Vₜₕ, the neuron emits a spike and resets. Synaptic weights can be adapted via local rules such as Spike-Timing-Dependent Plasticity (STDP), which represents a synaptic learning mechanism where the precise timing between a firing of a presynaptic neuron and a firing of a postsynaptic neuron determines whether the connection (e.g., synapse) is strengthened or weakened. For example, a presynaptic spike occurring immediately before the postsynaptic spike strengthens the synapse, while a postsynaptic spike occurring first weakens the synapse. The STDP mechanism is shown in connection with Equation 2, which links weight changes (Aw) to the precise timing of pre-synaptic spikes (represented as tₚᵣₑ) and post-synaptic spikes (represented as tₚₒₛₜ):

$$Δ w ∝ exp ( - \vert Δ t \vert / {τ}_{+ / -} ) Δ t = {t}_{post} - {t}_{pre} \qquad Equation 2$$

For a photo-sensitive neuro-transducer associated with the neuro-transducer tile array 115, the membrane potential Vₘ(t) evolves as shown in connection with Equation 3, such that the original input term RₘI(t) is replaced by αΦ_{light}(t), where Φ_{light}(t) represents the incident photon flux (e.g., in Lumens) and a represents the transduction coefficient (e.g., in Volts/Lumen):

$${τ}_{m} \frac{{dV}_{m} ( t )}{dt} = - ( {V}_{m} ( t ) - {V}_{rest} ) + α {Φ}_{light} ( t ) \qquad Equation 3$$

In examples disclosed herein, the physical stimulus sensing is no longer a separate step, and instead is the direct driving force of the neuron's dynamics. This represents an improvement over know methods that include the use of a Dynamic Vision Sensor (DVS) (e.g., as part of event-based cameras), which mimics the retina by having each pixel operate asynchronously. As such, a pixel only reports an event (e.g., represented by E(x, y, t, p)) if the logarithmic change in the event brightness/exceeds a certain threshold theta (θ), as shown in connection with Equation 4, where p is the polarity of the change (+1 or −1):

$$E ( x , y , t , p ) if \vert log ( I ( x , y , t ) ) - log ( I ( x , y , t - Δ t ) ) \vert > θ \qquad Equation 4$$

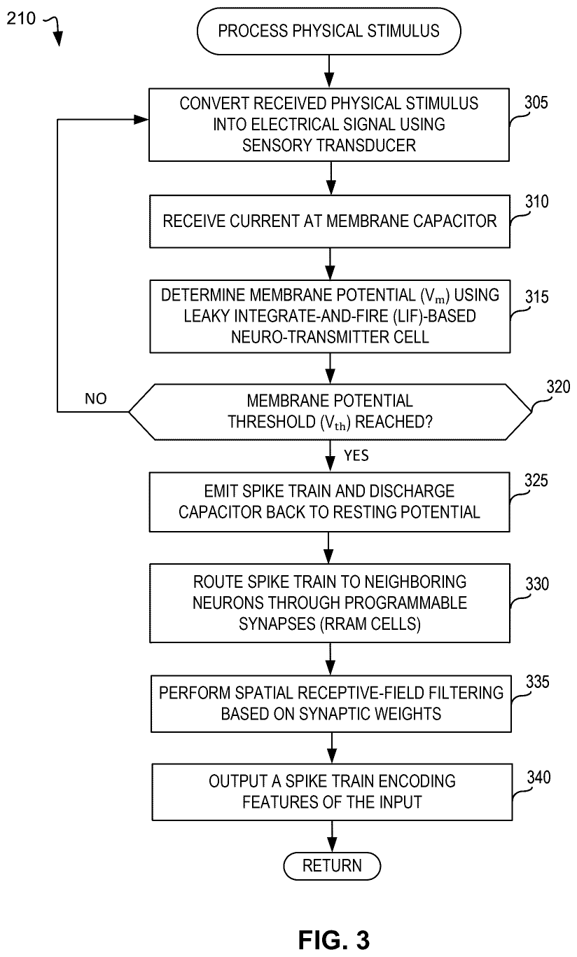

In examples disclosed herein, each pixel's physical stimulus (e.g., Φ(t)) directly drives a LIF neuron, as shown in connection with Equation 3, yielding high-level spike patterns (e.g., edges, corners, textures) with a reduced power usage (e.g., less than 1 mW/cm²) and a reduced latency (e.g., less than 100 microseconds). As described in more detail in connection with FIGS. 2-3, when Vₘ has reached a firing threshold (Vₜₕ), a spike event is generated while a reset transistor discharges the capacitor back to resting potential (Vᵣₑₛₜ), creating an all-or-nothing spike pulse which is routed to neighboring neurons through the programmable synapses (e.g., RRAM cells). For example, each synapse has a weight (wᵢⱼ) that determines whether the spike strongly excites a neighboring neuron, has a weak effect, or potentially inhibitory effect. This enables spatial receptive-field filtering (e.g., Difference-of-Gaussians (DoG) edge detectors, motion-selective filters, orientation-selective fields, etc.), such that the synaptic weights represent learned feature extractors at the sensor level. After propagation, the neuromorphic computing performer circuitry 102 outputs a spike train encoding features of the input (e.g., instead of raw pixels). In some examples, a uniform illumination results in no spikes, an edge contrast results in bursts of spikes along the edge, and a motion results in sequential spike propagation.

As compared to known spiking or in-sensor AI chips, the neuromorphic computing performer circuitry 102 disclosed herein includes synaptic programmability, a full LIF, and multi-modal transduction. For example, some known neuromorphic computing systems (e.g., Intel® Loihi 2) may include on-chip synaptic programmability, but only in the core SNN instead of on a per-pixel level as disclosed herein. In some examples, known systems using an in-pixel filter can include static, fixed filter weights, while back-end-of-line (BEOL) neurons are single-synapse-based and non-programmable. In comparison, the neuromorphic computing performer circuitry 102 disclosed herein includes per-neighbor non-volatile programmable synapses (e.g., multi-bit RRAM) embedded in monolithic BEOL, enabling on-die spatial receptive-field programming (e.g., DoG) without off-chip encoding. Similarly, known systems do not include a per-pixel, full LIF neuron driven directly by a physical stimulus as disclosed herein (e.g., as compared to a pixel that reports changes in current or frames). Additionally, the multi-modal transduction and circuit-level embodiment in examples disclosed herein is not present in known systems (e.g., Intel® Loihi 2, Dynamic Vision Sensor (DVS), in-pixel filters, BEOL-based neurons, etc.), with the neuromorphic computing performer circuitry 102 disclosed herein further allowing for use of quantum-dot, piezo materials.

Furthermore, when the neuro-transducers associated with the neuro-transducer tile array 115 are connected, complex computations can be performed by programming the synaptic weights (wᵢⱼ) between neighbouring cells. For example, to create an edge detector, the weights can be set in a Difference of Gaussians (DoG) pattern (e.g., with positive weights for near neighbours and negative weights for farther neighbours). A cell j fires based on the weighted sum of spikes from its neighbours I, as shown in connection with Equation 5, where

$$K ( t - {t}_{i}^{k} )$$

represents a voltage change caused by a spike from neuron i at time tᵢ^{k}:

$${V}_{j} ( t ) = {\sum }_{i ϵ {N}_{j}} {w}_{ij} {\sum }_{k} K ( t - {t}_{i}^{k} ) \qquad Equation 5$$

For example, with antagonistic weights, cell j fires when there is a sharp spatial contrast (e.g., an edge) in the stimulus across its neighbors.

In examples disclosed herein, spatial filters are natively computed by setting a synaptic matrix W in patterns. In an edge detector, positive weights are on near neighbours, and negative weights are on farther neighbours, while a corner detector uses rotated DoG patterns, and a motion filter uses asymmetric weights with a temporal kernel K(t−tₖ). The firing condition for neuron j can be defined as shown in connection with Equation 6, such that the neuron j fires only on sharp and/or temporal contrast.

$${V}_{j} ( t ) = {\sum }_{i , k} {w}_{ij} K ( t - {t}_{i}^{k} ) \qquad Equation 6$$

In examples disclosed herein, the neuromorphic computing performer circuitry 102 performance can be extrapolated based on the defined components, yielding practical, quantitative projections. For example, the power consumption of the disclosed system is projected to be less than 1 milliwatt (for a squared centimeter patch) as compared to traditional and event-based systems (e.g., DVS), which can include power consumptions ranging from watts to 1-10 milliwatts. Similarly, end-to-end latency of the disclosed system is projected to be less than 100 microseconds, compared to a latency of more than 30 milliseconds for traditional systems and 1-5 milliseconds for event-based systems. The data output of the disclosed system would be less than 1 megabits per second (Mbps) (e.g., feature-based), as compared to a data output of more than 500 Mbps for traditional systems and between 1 to 20 Mbps (e.g., activity dependent) for event-based systems. Additionally, the level of abstraction of the system disclosed herein would include complex features (e.g., edges, corners, textures, etc.), as opposed to the raw pixels of the traditional systems and pixel-level brightness changes associated with event-based systems.

By eliminating the separate data transfer and encoding stages (e.g., constituting more than 50% of the power budget in a DVS system), methods and apparatus disclosed herein offer at least an improvement of 10 times in both power efficiency and latency over the best current-generation event-based solutions, allowing for instant, ultra-low-power environmental perception. Furthermore, the system design disclosed herein is a complete departure from CMOS image sensor design, such that instead of a photodiode next to digital readout circuitry and ADCs, there is a direct physical coupling of a sensory material (e.g., a piezoelectric polymer for pressure, a quantum dot for light, etc.) with the analog components of a neuron circuit (e.g., memristors and capacitors). Applying a physical stimulus (e.g., shining a focused light beam) on the disclosed system would not produce a stable analog voltage or digital value, but instead yield a stream of all-or-nothing asynchronous voltage spikes. The frequency and timing of these spikes would directly encode the stimulus intensity, a behavior that is distinct from any other known sensor. Likewise, the outputs of the neuromorphic computing performer circuitry 102 disclosed would be fundamentally different from existing systems, such that while a DVS outputs a stream of (x, y, t, p) events, outputs from the neuromorphic computing performer circuitry 102 disclosed herein could include specific, sparse spike patterns.

A device stack associated with the neuromorphic computing performer circuitry 102 represents a unique arrangement allowing the LIF to be used as part of neuromorphic computation. In examples disclosed herein, the neuro-transducer tile array 115 of FIG. 1 includes transducer pixel cell(s) (e.g., 3T-1M pixel circuit components with capacitor and comparator). For example, a photonic transducer can include a quantum-dot layer (e.g., 50 nanometer thickness) deposited in BEOL on a top metal. In examples disclosed herein, a membrane capacitor can include a 1 picofarad (pF) Metal Insulator Metal (MIM) capacitor (e.g., with a 0.5 μm² footprint). An integrate FET (Field-Effect Transistor) (M1) can include an NFET (N-channel Field-Effect Transistor) with a channel width/length (W/L) of 1 μm/180 nm (e.g., in CMOS Image Sensor (CIS)), while a leak FET (M2) includes a NFET with a W/L of 0.2 μm/180 nm, providing constant conductance to ground (e.g., representing a model's leak). In examples disclosed herein, the threshold comparator is a two-stage CMOS comparator with a reference threshold (Vₜₕ) of 1 Volt. The reset FET (M3) can be a NFET with a W/L of 0.5 μm/180 nm, driven by a comparator output to discharge the capacitor (Cₘ). In examples disclosed herein, the RRAM synapse (e.g., per neighbor neuron) can be a titanium dioxide (TiO₂)-based RRAM cell (e.g., with a 50×50 nanometer footprint) in BEOL above the M1/M2 (e.g., one per directional neighbor).

In examples disclosed herein, bias conditions define the operating points of the disclosed circuitry, set key parameters, and permit for the brain-like functions associated with neuromorphic computing. These bias conditions include a Voltage Drain Drain (VDD) of 1.2 Volts, a resting membrane potential (Vᵣₑₛₜ) node biased at 0.2 Volts, a leak bias (Vₗₑₐₖ) of 0.6 Volts across M2 (e.g., yielding a membrane time constant τₘ of 10 milliseconds), and a comparator reference generated by an on-chip bandgap. Furthermore, a small-array floorplan (e.g., on a 4×4 tile) representing a schematic arrangement of the major functional blocks of the integrated circuit disclosed herein can be arranged as shown below, where each [Pij] block (e.g., [P00], P[01], . . . . P[33]) represents a single pixel including four RRAM synapses to north, south, east, and west neuron neighbors:

| | |
|---|---|
| Row0: | [P00][P01][P02][P03] |
| | [ S ] [ S ]...SPIKE BUS |
| Row1: | [P10][P11][P12][P13] |
| | ........................ |
| Row3: | [P30][P31][P32][P33] |

In examples disclosed herein, the routing is performed via a local AER mesh that connects comparators to row and column encoders, with the small-array floorplan area including 25×25 μm² per pixel (e.g., 100×100 μm² for a 4×4 tile).

In examples disclosed herein, the RRAM cells can be programmed via write drivers on per-row rails (e.g., using a 4-bit weight resolution). Additionally, update protocol(s) used herein are STDP-compatible, with coincidence detectors at each synapse for comparing pre-spike and post-spike timing and generation of short voltage pulses (±0.5 Volts) on the RRAM, with weight increases when Δt>0 and weight decreases when Δt<0. In examples disclosed herein, a 10-year data retention is guaranteed, with an endurance of more than 106 cycles. In the example of FIG. 1, spike routing is performed based on (1) comparator fires that are used to assert local spike line(s) (e.g., originating from the neuro-transducer tile array 115), (2) logging of spike events by a row encoder (e.g., local AER encoder 130), with broadcasting to neighbor rows via an AER crossbar, (3) receiving of the spike line by neighboring pixels (e.g., with a change of the membrane capacitance (Cₘ) through RRAM-proportional conductance wᵢⱼ (e.g., associated with the local synaptic array 125), and (4) collection by a global arbiter for an off-chip Host via a PCIe-AER bridge (e.g., global arbiter/PCIe-AER bridge 135).

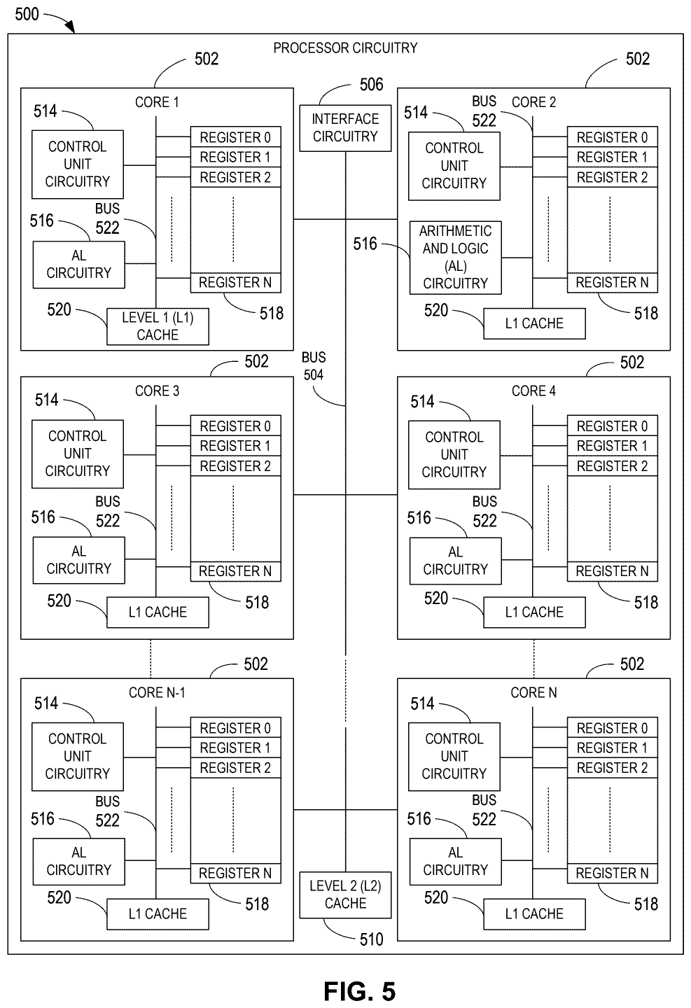

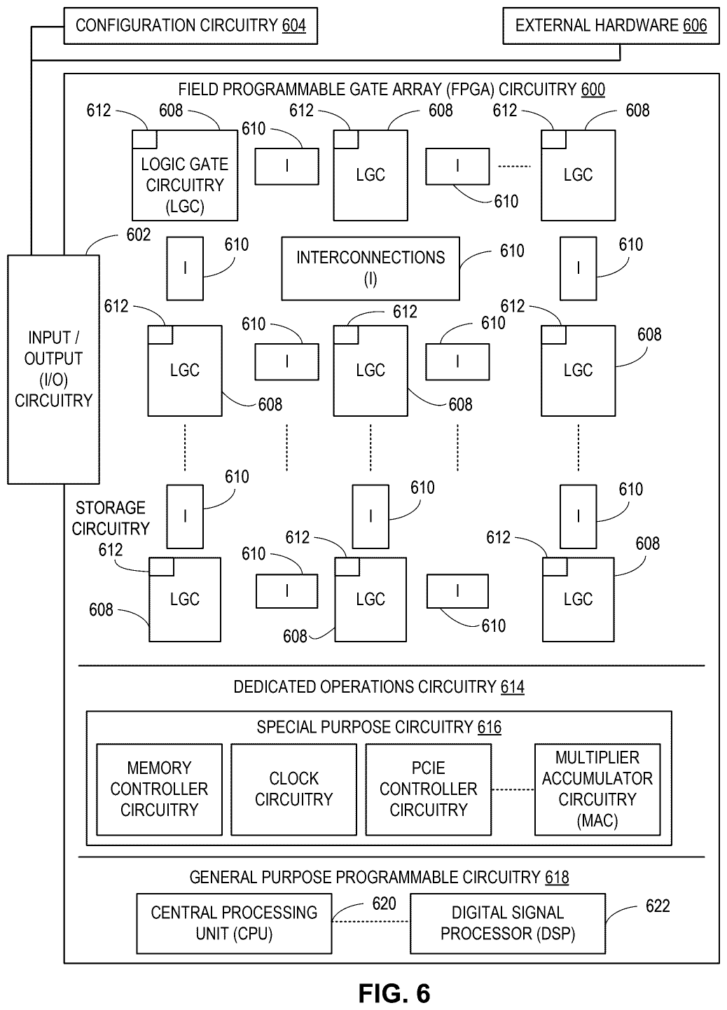

In some examples, the apparatus includes means for receiving a physical stimulus. For example, the means for receiving a physical stimulus may be implemented by the optics/mechanical coupling 110. In some examples, the optics/mechanical coupling 110 may be instantiated by the example microprocessor 500 of FIG. 5 executing machine executable instructions such as those implemented by at least block(s) 205 of FIG. 2. In some examples, the optics/mechanical coupling 110 may be instantiated by hardware logic circuitry, which may be implemented by an ASIC, XPU, or the FPGA circuitry 600 of FIG. 6 structured to perform operations corresponding to the machine readable instructions.

In some examples, the apparatus includes means for generating a spike train input based on a physical stimulus. For example, the means for generating a spike train input based on the physical stimulus may be implemented by the neuro-transducer tile array 115. In some examples, the neuro-transducer tile array 115 may be instantiated by the example microprocessor 500 of FIG. 5 executing machine executable instructions such as those implemented by at least block(s) 310, 315, 320, 325 of FIG. 3. In some examples, the neuro-transducer tile array 115 may be instantiated by hardware logic circuitry, which may be implemented by an ASIC, XPU, or the FPGA circuitry 600 of FIG. 6 structured to perform operations corresponding to the machine readable instructions.

In some examples, the apparatus includes means for routing a spike train through programmable synapses. For example, the means for routing a spike train through programmable synapses may be implemented by the local synaptic array (RRAM) 125. In some examples, the local synaptic array (RRAM) 125 may be instantiated by the example microprocessor 500 of FIG. 5 executing machine executable instructions such as those implemented by at least block(s) 330 of FIG. 3. In some examples, the local synaptic array (RRAM) 125 may be instantiated by hardware logic circuitry, which may be implemented by an ASIC, XPU, or the FPGA circuitry 600 of FIG. 6 structured to perform operations corresponding to the machine readable instructions.

In some examples, the apparatus includes means for outputting a feature-level spike train. For example, the means for outputting a feature-level spike train may be implemented by the local AER encoders 130. In some examples, the local AER encoders 130 may be instantiated by the example microprocessor 500 of FIG. 5 executing machine executable instructions such as those implemented by at least block(s) 340 of FIG. 3. In some examples, the local AER encoders 130 may be instantiated by hardware logic circuitry, which may be implemented by an ASIC, XPU, or the FPGA circuitry 600 of FIG. 6 structured to perform operations corresponding to the machine readable instructions.

In some examples, the apparatus includes means for performing tasks using ML accelerators or event-driven decision units. For example, the means for means for performing tasks using ML accelerators or event-driven decision units may be implemented by the downstream edge ML accelerator/MCU 140. In some examples, the downstream edge ML accelerator/MCU 140 may be instantiated by the example microprocessor 500 of FIG. 5 executing machine executable instructions such as those implemented by at least block(s) 220 of FIG. 2. In some examples, the downstream edge ML accelerator/MCU 140 may be instantiated by hardware logic circuitry, which may be implemented by an ASIC, XPU, or the FPGA circuitry 600 of FIG. 6 structured to perform operations corresponding to the machine readable instructions.

While an example manner of implementing the neuromorphic computing performer circuitry 102 is illustrated in FIG. 1, one or more of the elements, processes and/or devices illustrated in FIG. 1 may be combined, divided, re-arranged, omitted, eliminated and/or implemented in any other way. Further, the neuromorphic computing performer circuitry 102 of FIG. 1 may be implemented by hardware, software, firmware and/or any combination of hardware, software and/or firmware. Thus, for example, the neuromorphic computing performer circuitry 102 of FIG. 1 could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), vision processing units (VPUs), and/or field programmable logic device(s) (FPLD(s)) such as FPGAs in combination with machine readable instructions (e.g., firmware or software). Further still, the neuromorphic computing performer circuitry 102 of FIG. 1 may include one or more elements, processes, and/or devices in addition to, or instead of, those illustrated in FIG. 1, and/or may include more than one of any or all of the illustrated elements, processes and devices.

Flowcharts representative of example machine readable instructions, which may be executed by programmable circuitry to implement and/or instantiate the neuromorphic computing performer circuitry 102 of FIG. 1 and/or representative of example operations which may be performed by programmable circuitry to implement and/or instantiate the neuromorphic computing performer circuitry 102 of FIG. 1, are shown in FIGS. 2-3. The machine readable instructions may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 2-3, many other methods of implementing the neuromorphic computing performer circuitry 102 of FIG. 1 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine-readable instructions and/or example operations 200 that may be executed, instantiated, and/or performed by example programmable circuitry to implement the example neuromorphic computing performer circuitry 102 of FIG. 1. The machine-readable instructions and/or the operations 200 of FIG. 2 begin at block 205, at which the neuro-transducer tile array 115 detects a raw physical stimulus (e.g., physical stimulus 105 of FIG. 1) at the neuro-transducer tile array 115 via the optics/mechanical coupling 110 of FIG. 1. The neuro-transducer tile array 115 proceeds to process the physical stimulus, at block 210, as described in more detail in connection with FIG. 3. For example, the transducer of the neuro-transducer tile array 115 (e.g., quantum-dot photodiode, piezo layer, etc.) converts the physical stimulus into an electrical signal (e.g., current or voltage) and determines a membrane potential using the LIF-based neuro-transmitter cells, emitting a spike train when the membrane potential threshold is reached. After processing of the spike train using the local synaptic array 125, the local AER encoders/spike bus 130 output the spike train to the downstream edge ML accelerator/MCU 140. For example, when the downstream edge ML accelerator/MCU 140 determines to perform further processing of feature spike trains for higher level tasks, at block 215, the downstream edge ML accelerator/MCU 140 receives the feature spike trains from the local AER encoders/spike bus 130. The downstream edge ML accelerator/MCU 140 and/or event-driven decision units perform the higher-level tasks based on the received feature spike trains, at block 220.

In some examples, the spike trains feed into the ML accelerator 140 (e.g., neural processing unit (NPU), tensor processing units (TPU), Intel® Loihi, etc.) to run tasks such as, but not limited to, gesture recognition (e.g., hand raise, swipe, sign language), object recognition (e.g., person, car, pet), keyword spotting (e.g., lip movements tied to speech), and/or anomaly detection (e.g., abnormal vibration, flicker, thermal pattern). In some examples, the spike train output can drive a simple finite-state machine (FSM), microcontroller, or edge decision logic. For example, a spike burst can be interpreted as a detected motion, waking up a host central processing unit (CPU), whereas specific spike patterns can be representative of a recognized gesture, sending a command to a wearable device. In some examples, repeated spike edges can be used to trigger adaptive exposure or focus (e.g., in a camera module).

FIG. 3 is a flowchart representative of example machine-readable instructions and/or example operations 210 that may be executed, instantiated, and/or performed by the example neuromorphic computing performer circuitry 102 of FIG. 1 to process a physical stimulus. The machine-readable instructions and/or the operations 210 of FIG. 2 begin at block 305, at which the neuro-transducer tile array 115 converts the received physical stimulus (e.g., physical stimulus 105 of FIG. 1) into an electrical signal. As previously described in connection with FIG. 1, the physical stimulus can be a light intensity (e.g., photons hitting a pixel), an acoustic pressure wave (e.g., sound), or a mechanical strain (e.g., touch/vibration). As such, the physical stimulus (Φ(t)) represents a time-varying function that drives charge/current into the transducer. The sensory transducer (e.g., quantum-dot photodiode, piezo layer, etc.) converts the physical stimulus into an electrical signal, such that a strong event (e.g., sudden edge contrast in vision), causes Φ(t) to increase sharply, representing an input current stimulus that drives the neurons of the neuro-transducer tile array 115. In the example of FIG. 3, the neuro-transducer tile array 115 receives the resulting current at a membrane capacitor (Cₘ) of the pixel, at block 310.

Subsequently, the neuro-transducer tile array 115 determines the membrane potential (Vₘ) using a LIF-based neuro-transmitter cell, at block 315. For example, LIF integration can be represented as Vₘ←Vₘ+α·Φ(t)-leak, with Vₘ representing the membrane potential stored on the capacitor, α·(t) representing an input energy that charges the capacitor, and the leak term implemented by a small transistor (M2), continuously discharging the capacitor. As such, a weak stimulus results in a decay of the membrane potential, while a sustained and/or strong stimulus results in the gradual rising of the membrane potential, contributing to temporal accumulation. In the example of FIG. 3, the neuro-transducer tile array 115 determines whether the membrane potential threshold (Vₜₕ) (e.g., firing threshold) has been reached, at block 320. For example, a comparator checks if the membrane potential has reached the firing threshold, such that when Vₘ<Vₜₕ, integration of the physical stimulus input continues, whereas when Vₘ≥Vₜₕ, a spike event is generated, such that determination of the threshold as disclosed herein makes the detection event-driven as opposed to being continuous.

Once the threshold is crossed, the neuro-transducer tile array 115 emits the spike train and discharges the capacitor back to resting potential, at block 325. For example, once the threshold is crossed, the comparator output increases significantly, generating a digital spike (e.g., event packet), while a reset transistor discharges the capacitor back to the resting potential (Vᵣₑₛₜ). As such, an all-or-nothing spike pulse is emitted, replicating the function of a biological neuron. In examples disclosed herein, the local synaptic array 125 routes the spike train to neighboring neurons through programmable synapses (e.g., RRAM cells), at block 330. The local synaptic array 125 and/or the local AER encoders/spike bus 130 performs spatial receptive-field filtering based on the synaptic weights, at block 335.

For example, as previously described in connection with FIG. 1, each synapse has a weight (wᵢⱼ), such that if a weight is high, the spike strongly excites the neighboring neuron, if a weight is low, there is a weak effect, and if a weight is negative, an inhibitory effect is possible. The synaptic weights represent learned feature extractors at the sensor level. Based on the changing weights, spatial receptive-field filtering is performed using Difference-of-Gaussians (DoG) edge detectors, motion-selective filters, and/or orientation-selective fields. In the example of FIG. 3, the local AER encoders/spike bus 130 output a spike train encoding features of the input, at block 340. In some examples, uniform illumination can be represented as no spikes, edge contrast can be represented as bursts of spikes along the edge, and motion can be represented as sequential spike propagation. Subsequently, this spike train (e.g., representing a compressed, event-driven, semantic output) is directed towards downstream machine learning and/or control (e.g., System-on-Chip (SoC), wearable AI, spiking neural network (SNN) accelerator, etc.), as described in connection with FIG. 2.

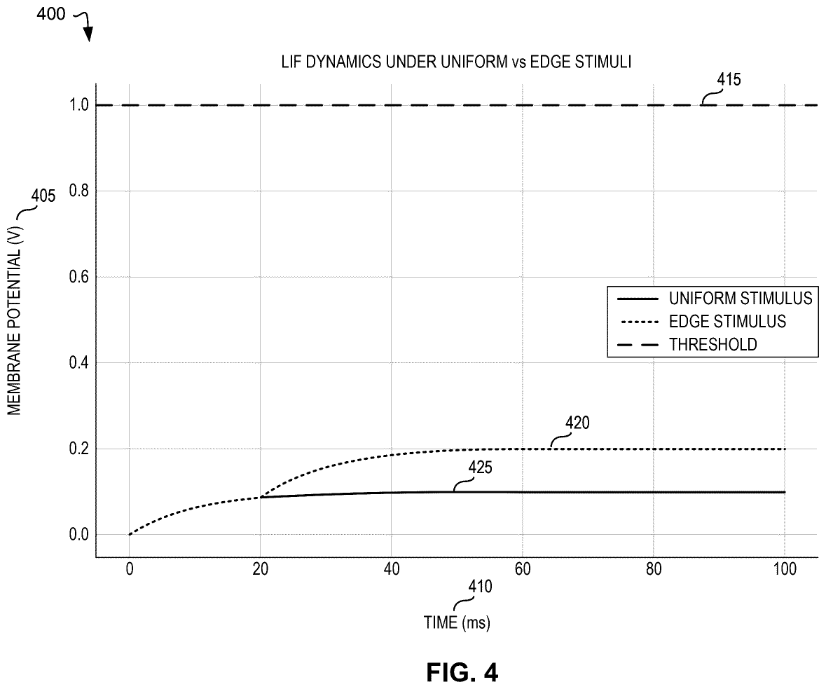

FIG. 4 is an example graph 400 of Leaky Integrate-and-Fire (LIF) neural model dynamics under uniform and edge stimuli. In the example of FIG. 4, the graph 400 is generated using a circuit simulation program (e.g., Simulation Program with Integrated Circuit Emphasis (SPICE)). In the example of FIG. 4, LIF dynamics are shown under uniform and edge stimuli illustrating changes in membrane potential 405 over time 410, including a threshold 415, an edge stimulus 420, or a uniform stimulus 425. Under a 0.2 V-equivalent photon flux, the membrane potential (Vₘ) rises slowly and never spikes. When the edge stimulus doubles (e.g., at t=20 milliseconds), the membrane potential crosses the membrane threshold (Vₜₕ) and resets, demonstrating programmable responsiveness. In the example of FIG. 4, the physical stimulus directly drives LIF dynamics, with a threshold behavior and reset that are CMOS-implemented.

In examples disclosed herein using a DoG edge detector, the SPICE model indicates that flat illumination yields a sub-threshold membrane potential (Vₘ), while a 1 Volt differential on neighbors produces a 1.2 V peak, crossing the 1 Volt threshold. This simulation is associated with a receptive-field example, such that only a sharp local contrast produces net positive current into the central pixel's membrane capacitor (Cₘ), triggering a spike. A weight kernel associated with such a receptive-field example is shown below:

$$W = [ \begin{matrix}0 & + 1 & 0 \\ + 1 & - 4 & + 1 \\ 0 & + 1 & 0\end{matrix} ]$$

FIG. 5 is a block diagram of an example implementation of programmable circuitry disclosed herein structured to execute, instantiate, and/or perform the example machine readable instructions and/or perform the example operations of FIGS. 2-3 to implement the example neuromorphic computing performer circuitry 102 of FIG. 1, In this example, the programmable circuitry is implemented by a microprocessor 500. For example, the microprocessor 500 may be a general purpose microprocessor (e.g., general purpose microprocessor circuitry). The microprocessor 500 executes some or all of the machine readable instructions of the flowcharts of FIGS. 2-3 to effectively instantiate the circuitry of FIG. 1 logic circuits to perform the operations corresponding to those machine readable instructions. In some such examples, the circuitry of FIG. 1 is instantiated by the hardware circuits of the microprocessor 500 in combination with the instructions. For example, the microprocessor 500 may implement multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowcharts of FIGS. 2-3.

The cores 502 may communicate by a first example bus 504. In some examples, the first bus 504 may implement a communication bus to effectuate communication associated with one(s) of the cores 502. For example, the first bus 504 may implement at least one of an Inter-Integrated Circuit (I2C) bus, a Serial Peripheral Interface (SPI) bus, a PCI bus, or a PCIe bus. Additionally or alternatively, the first bus 504 may implement any other type of computing or electrical bus. The cores 502 may obtain data, instructions, and/or signals from one or more external devices by example interface circuitry 506. The cores 502 may output data, instructions, and/or signals to the one or more external devices by the interface circuitry 1106. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2_cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and a main memory. Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the L1 cache 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer-based operations. In other examples, the AL circuitry 516 also performs floating-point operations. In yet other examples, the AL circuitry 516 may include first AL circuitry that performs integer-based operations and second AL circuitry that performs floating point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

FIG. 6 is a block diagram of another example implementation of the programmable circuitry disclosed herein as implemented by FPGA circuitry 600. For example, the FPGA circuitry 600 may be implemented by an FPGA. The FPGA circuitry 600 can be used, for example, to perform operations that could otherwise be performed by the example microprocessor 600 of FIG. 6 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 2-3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 2-3. In particular, the FPGA 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 2-3. As such, the FPGA circuitry 600 may be configured and/or structured to effectively instantiate some or all of the operations/functions corresponding to the machine readable instructions of the flowcharts of FIGS. 2-3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIGS. 2-3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIGS. 2-3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry disclosed herein, many other approaches are contemplated. For example, FPGA circuitry may include an on-board CPU, such as one or more of the example CPU 620 of FIG. 6. Therefore, the programmable circuitry may additionally be implemented by combining at least the example microprocessor 500 of FIG. 5 and the example FPGA circuitry 600 of FIG. 6. In some such hybrid examples, one or more cores 602 of FIG. 6 may execute a first portion of the machine readable instructions represented by the flowchart(s) of FIGS. 2-3 to perform first operation(s)/function(s), the FPGA circuitry 600 of FIG. 6 may be configured and/or structured to perform second operation(s)/function(s) corresponding to a second portion of the machine readable instructions represented by the flowcharts of FIGS. 2-3, and/or an ASIC may be configured and/or structured to perform third operation(s)/function(s) corresponding to a third portion of the machine readable instructions represented by the flowcharts of FIGS. 2-3.

It should be understood that some or all of the circuitry of FIG. 1 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIG. 1 may be implemented within one or more virtual machines and/or containers executing on the microprocessor 500 of FIG. 5.

In some examples, the programmable circuitry disclosed herein may be in one or more packages. For example, the microprocessor 500 of FIG. 5 and/or the FPGA circuitry 600 of FIG. 6 may be in one or more packages. In some examples, an XPU may be implemented by the programmable circuitry which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein integrate per-pixel neuro-transducer LIF neurons with programmable per-neighbor nonvolatile synapses (RRAM) in a monolithic die, producing feature-level spike trains at the sensor that drastically reduce end-to-end latency and energy. For example, each neuro-transducer cell behaves like a leaky integrate-and-fire (LIF) neuron whose input is the raw stimulus instead of an injected current. The resulting advantages of using methods and apparatus disclosed herein include ultra-low power (<1 mW/cm²) (e.g., applicable for a year-long battery life for wearables, structural health monitors, etc.), instantaneous perception (<100 μs) (e.g., applicable for closed-loop control in micro-drones, robotics, prosthetics, etc.), and presence of edge-native features (e.g., applicable for simplified Machine Learning (ML) stacks, reduced transmission bandwidth, privacy by design, etc.). Thus, examples disclosed herein result in improvements to the operation of a machine.

Example methods, apparatus, systems, and articles of manufacture for fusion of sensory transduction and neuromorphic computation are disclosed herein. Further examples and combinations thereof include the following:

Example 1 includes an apparatus, comprising a neuro-transducer with one or more in-pixel Leaky Integrate-and-Fire (LIF) neurons to generate a spike train input based on a physical stimulus, and a synaptic array with programmable nonvolatile synapses to output a feature-level spike train based on the spike train input from the neuro-transducer, the feature-level spike train used for a downstream high-level task.

Example 2 includes the apparatus as defined in example 1, wherein the synaptic array generates the feature-level spike train based on an encoding of input features, the input features including at least one of an edge detection, a corner detection, or a motion flow detection.

Example 3 includes the apparatus as defined in one or more of examples 1-2, wherein the downstream high-level task is performed by at least one of a machine learning accelerator or an event-driven decision unit.

Example 4 includes the apparatus as defined in one or more of examples 1-3, wherein the neuro-transducer is to determine a membrane potential using the one or more LIF neurons.

Example 5 includes the apparatus as defined in one or more of examples 1-4, wherein the neuro-transducer is to generate the spike train input when the membrane potential meets or exceeds a membrane potential threshold.

Example 6 includes the apparatus as defined in one or more of examples 1-5, wherein the programmable nonvolatile synapses are Resistive Random-Access Memory (RRAM) cells embedded in a monolithic back-end-of-line (BEOL) layer.

Example 7 includes the apparatus as defined in one or more of examples 1-6, wherein the synaptic array is to perform spatial receptive-field filtering of the spike train input based on synaptic weights.

Example 8 includes the apparatus as defined in one or more of examples 1-7, wherein the synaptic weights are updated based on Spike-Timing-Dependent Plasticity (STDP).

Example 9 includes the apparatus as defined in one or more of examples 1-8, further including a feature-packet Address Event Representation (AER) as part of a global arbiter to collect data from a local AER encoder, the local AER encoder in communication with the synaptic array.

Example 10 includes an apparatus, comprising a sensory material to sense a physical stimulus, a Leaky Integrate-and-Fire (LIF) neuron to generate a spike train based on the physical stimulus, and a synaptic array to process the spike train based on synaptic weights as part of spatial receptive-field filtering, and output a feature-level spike train based on features of the physical stimulus.

Example 11 includes the apparatus as defined in example 10, wherein the sensory material is at least one of a piezoelectric polymer or a quantum dot.

Example 12 includes the apparatus as defined in one or more of examples 10-11, wherein the spatial receptive-field filtering includes at least one of a Difference-of-Gaussians (DoG) edge detector, a DoG corner detector, or a motion filter.

Example 13 includes the apparatus as defined in one or more of examples 10-12, wherein the synaptic array includes Resistive Random-Access Memory (RRAM) cells to perform the spatial receptive-field filtering.

Example 14 includes the apparatus as defined in one or more of examples 10-13, wherein the LIF neuron emits the spike train and resets when a membrane potential exceeds a membrane threshold.

Example 15 includes the apparatus as defined in one or more of examples 10-14, wherein a machine learning accelerator receives the feature-level spike train to perform at least one of a gesture recognition, an object recognition, a keyword spotting, or an anomaly detection.

Example 16 includes the apparatus as defined in one or more of examples 10-15, wherein at least one of a finite-state machine, a microcontroller, or an edge decision logic triggers an action based on a characteristic of the feature-level spike train, the characteristic at least one of a spike burst, a repeated spike edge, or a spike pattern.

Example 17 includes an apparatus, comprising means for generating a spike train input based on a physical stimulus, and means for outputting a feature-level spike train based on the spike train input from the means for generating the spike train, the feature-level spike train used for a downstream high-level task.

Example 18 includes the apparatus as defined in example 17, wherein the means for outputting the feature-level spike train includes encoding input features in the spike train, the input features including at least one of an edge detection, a corner detection, or a motion flow detection.

Example 19 includes the apparatus as defined in one or more of examples 17-18, wherein the downstream high-level task is performed by at least one of a machine learning accelerator or an event-driven decision unit.

Example 20 includes the apparatus as defined in one or more of examples 17-19, wherein the means for outputting the feature-level spike train includes programmable nonvolatile synapses, the programmable nonvolatile synapses including Resistive Random-Access Memory (RRAM) cells embedded in a monolithic back-end-of-line (BEOL) layer.

Example 21 includes the apparatus as defined in one or more of examples 17-20, wherein the means for generating a spike train input is to determine a membrane potential using one or more Leaky Integrate-and-Fire (LIF) neurons.

Example 22 includes the apparatus as defined in one or more of examples 17-21, wherein the means for generating a spike train input is to generate the spike train input when the membrane potential meets or exceeds a membrane potential threshold.

Example 23 includes the apparatus as defined in one or more of examples 17-22, wherein the means for outputting a feature-level spike train is to perform spatial receptive-field filtering of the spike train input based on synaptic weights.

Example 24 includes the apparatus as defined in one or more of examples 17-23, wherein the synaptic weights are updated based on Spike-Timing-Dependent Plasticity (STDP).

Example 25 includes the apparatus as defined in one or more of examples 17-24, further including means for collecting data from a local AER encoder, the local AER encoder in communication with the means for outputting a feature-level spike train.

Example 26 includes a method, comprising sensing, using a sensory material, a physical stimulus, generating a spike train based on the physical stimulus, processing, using a synaptic array, the spike train based on synaptic weights as part of spatial receptive-field filtering, and outputting a feature-level spike train based on features of the physical stimulus.

Example 27 includes the method as defined in example 26, wherein the sensory material is at least one of a piezoelectric polymer or a quantum dot.

Example 28 includes the method as defined in one or more of examples 26-27, wherein the spatial receptive-field filtering includes at least one of a Difference-of-Gaussians (DoG) edge detector, a DoG corner detector, or a motion filter.

Example 29 includes the method as defined in one or more of examples 26-28, wherein the synaptic array includes Resistive Random-Access Memory (RRAM) cells to perform the spatial receptive-field filtering.

Example 30 includes the method as defined in one or more of examples 26-29, further including emitting the spike train from a Leaky Integrate-and-Fire (LIF) neuron and resetting the LIF neuron when a membrane potential exceeds a membrane threshold.

Example 31 includes the method as defined in one or more of examples 26-30, further including receiving the feature-level spike train to perform at least one of a gesture recognition, an object recognition, a keyword spotting, or an anomaly detection.

Example 32 includes the method as defined in one or more of examples 26-31, further including triggering an action based on a characteristic of the feature-level spike train, the characteristic at least one of a spike burst, a repeated spike edge, or a spike pattern.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
a neuro-transducer with one or more in-pixel Leaky Integrate-and-Fire (LIF) neurons to generate a spike train input based on a physical stimulus; and
a synaptic array with programmable nonvolatile synapses to output a feature-level spike train based on the spike train input from the neuro-transducer, the feature-level spike train used for a downstream high-level task.

2. The apparatus of claim 1, wherein the synaptic array generates the feature-level spike train based on an encoding of input features, the input features including at least one of an edge detection, a corner detection, or a motion flow detection.

3. The apparatus of one of claims 1-2, wherein the downstream high-level task is performed by at least one of a machine learning accelerator or an event-driven decision unit.

4. The apparatus of one of claims 1-2, wherein the neuro-transducer is to determine a membrane potential using the one or more LIF neurons.

5. The apparatus of claim 4, wherein the neuro-transducer is to generate the spike train input when the membrane potential meets or exceeds a membrane potential threshold.

6. The apparatus of one of claims 1-2, wherein the programmable nonvolatile synapses are Resistive Random-Access Memory (RRAM) cells embedded in a monolithic back-end-of-line (BEOL) layer.

7. The apparatus of one of claims 1-2, wherein the synaptic array is to perform spatial receptive-field filtering of the spike train input based on synaptic weights.

8. The apparatus of one of claims 1-2, wherein the synaptic weights are updated based on Spike-Timing-Dependent Plasticity (STDP).

9. The apparatus of one of claims 1-2, further including a feature-packet Address Event Representation (AER) as part of a global arbiter to collect data from a local AER encoder, the local AER encoder in communication with the synaptic array.

10. An apparatus, comprising:
a sensory material to sense a physical stimulus;
a Leaky Integrate-and-Fire (LIF) neuron to generate a spike train based on the physical stimulus; and
a synaptic array to:
process the spike train based on synaptic weights as part of spatial receptive-field filtering; and
output a feature-level spike train based on features of the physical stimulus.

11. The apparatus of claim 10, wherein the sensory material is at least one of a piezoelectric polymer or a quantum dot.

12. The apparatus of one of claims 10-11, wherein the spatial receptive-field filtering includes at least one of a Difference-of-Gaussians (DoG) edge detector, a DoG corner detector, or a motion filter.

13. The apparatus of one of claims 10-11, wherein the synaptic array includes Resistive Random-Access Memory (RRAM) cells to perform the spatial receptive-field filtering.

14. The apparatus of one of claims 10-11, wherein the LIF neuron emits the spike train and resets when a membrane potential exceeds a membrane threshold.

15. The apparatus of one of claims 10-11, wherein a machine learning accelerator receives the feature-level spike train to perform at least one of a gesture recognition, an object recognition, a keyword spotting, or an anomaly detection.

16. The apparatus of one of claims 10-11, wherein at least one of a finite-state machine, a microcontroller, or an edge decision logic triggers an action based on a characteristic of the feature-level spike train, the characteristic at least one of a spike burst, a repeated spike edge, or a spike pattern.

17. An apparatus, comprising:
means for generating a spike train input based on a physical stimulus; and
means for outputting a feature-level spike train based on the spike train input from the means for generating the spike train, the feature-level spike train used for a downstream high-level task.

18. The apparatus of claim 17, wherein the means for outputting the feature-level spike train includes encoding input features in the spike train, the input features including at least one of an edge detection, a corner detection, or a motion flow detection.

19. The apparatus of one of claims 17-18, wherein the downstream high-level task is performed by at least one of a machine learning accelerator or an event-driven decision unit.

20. The apparatus of one of claims 17-18, wherein the means for outputting the feature-level spike train includes programmable nonvolatile synapses, the programmable nonvolatile synapses including Resistive Random-Access Memory (RRAM) cells embedded in a monolithic back-end-of-line (BEOL) layer.
